(19) United States
(12) Patent Application Publication
(10) Pub. No.: US 2015/0167890 A1
(43) Pub. Date: Jun. 18, 2015

(54) Cuff Device and Methods of Use Thereof

(71) Applicants: Karen West, Oceanside, CA (US); Barbara McKee, Santee, CA (US)

(72) Inventors: Karen West, Oceanside, CA (US); Barbara McKee, Santee, CA (US)

(21) Appl. No.: 14/106,691

(22) Filed: Dec. 13, 2013

(51) Int. Cl. F16M 13/04; A61G 12/00

(52) U.S. Cl. CPC F16M 13/04; A61G 12/00; A61G 2203/78

(57) ABSTRACT

A cuff device for securing a cord of a nurse call button to a portion of a body, the device having a strap having an interior surface, an exterior surface, a first end, and a second end, a padded portion engaged to the interior surface of the strap, a cuff fastening mechanism capable of releaseably securing the cuff device to a portion of the body, and a cord fastener capable of securing the cord to the strap, where the strap is capable of encircling a portion of the body.

### BACKGROUND

A nurse call button (also referred to as a nurse call light or nurse call bell) is a device used by patients in hospitals and other healthcare facilities, such as urgent care centers, ambulatory care clinics, outpatient surgical centers, nursing and veterans' homes. The device allows patients to request assistance from any member of a health care team. The nurse call button is often referred to as a patient's “lifeline” because it may be the sole means by which a patient can call for help, especially bedridden patients and those for whom walking is difficult, dangerous, or impossible.

The nurse call button, when it is not a part of the actual patient bed frame, generally includes a cord having a length of about 5-15 feet of which one end is capable of being plugged into the facility's call button management and intercom system in close proximity to the patient's bed. The other end of the cord can have a single pushbutton for calling the nurse or a controller with a specified pushbutton for calling the nurse.

If the nurse call button becomes inaccessible to the patient, the patient becomes isolated from the nursing staff; this causes anxiety for the patient and may result in a potentially dangerous and life-threatening situation. There is a myriad of reasons for why the nurse call button may become located outside the reach of the patient, among them: the nurse call button slipping off the side rail or bed and onto the floor; the patient turning or moving and losing sight of the nurse call button among linens and equipment; the patient being too tired or exhausted or medicated and accidently dropping or moving the nurse call button to a position in which it is no longer accessible; a member of a health care team being careless in where he/she places the nurse call button before leaving the patient's room; a member of a health care team moving the patient or the nurse call button so that it is no longer accessible to the patient; family members, friends, and colleagues inadvertently causing the nurse call button to become inaccessible to the patient.

Members of health care teams desire all patients to easily access a nurse call button so their needs can be met quickly to prevent the patients from suffering unnecessary stress and anxiety. Nursing staff have unsuccessfully endeavored to find effective ways to keep the nurse call button within sight and easy reach of their patients.

### SUMMARY OF THE INVENTION

The present disclosure pertains to a cuff device for securing a cord of a nurse call button to a portion of a body, the device having a strap having an interior surface, an exterior surface, a first end, and a second end, where the strap is capable of encircling a portion of the body, a padded portion engaged to the interior surface of the strap, a cuff fastening mechanism capable of releaseably securing the cuff device to a portion of the body, and a cord fastener capable of securing the cord to the strap.

In one aspect of the disclosure, the padded portion is capable of reducing friction between the strap and the skin of the portion of the body. In one aspect of the disclosure, the padded portion is capable of reducing irritation between the strap and the skin of the portion of the body. In another aspect of the disclosure, the padded portion has a width greater than the width of the strap. In another aspect of the disclosure, the cord fastener has a cord fastening mechanism and a flap having a first end and a second end, where the cord fastening mechanism is capable of releaseably engaging the second end of the flap to the exterior surface of the strap. In another aspect of the disclosure, the first end of the flap engages the exterior surface of the strap. In another aspect of the disclosure, the flap has a flap tab engaged to the second end of the flap. In another aspect of the disclosure is a strap tab engaging the first end of the strap. In another aspect of the disclosure is an adjustable mechanism capable of adjusting the compression force applied to a portion of the body.

With those and other objects, advantages and features on the invention that may become hereinafter apparent, the nature of the invention may be more clearly understood by reference to the following detailed description of the invention, the appended claims, and the drawings attached hereto.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a perspective view of a cuff according to an exemplary embodiment.

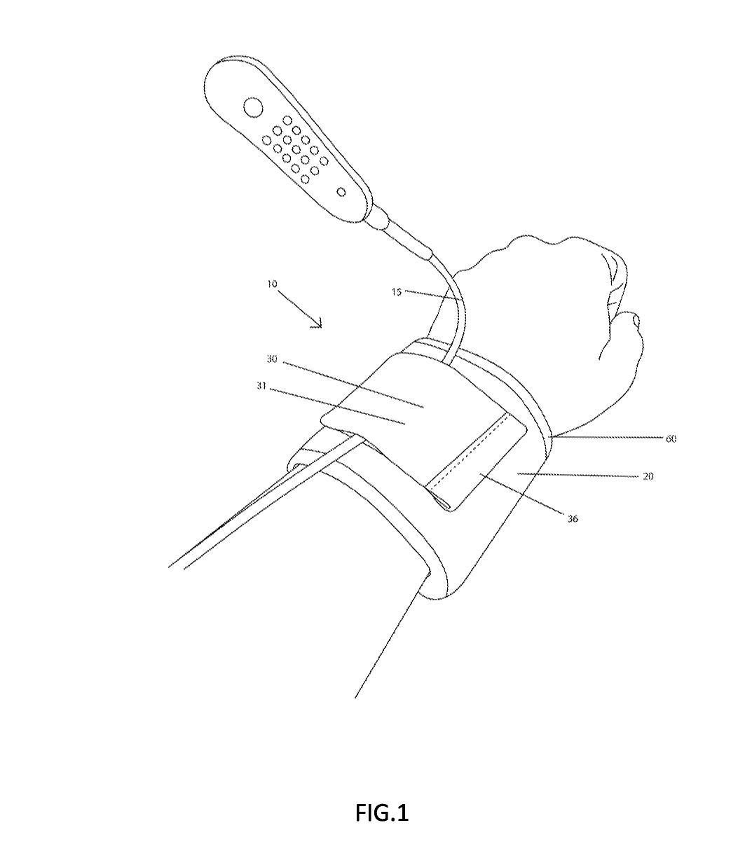

FIG. 2 is a perspective view of a cuff according to an exemplary embodiment.

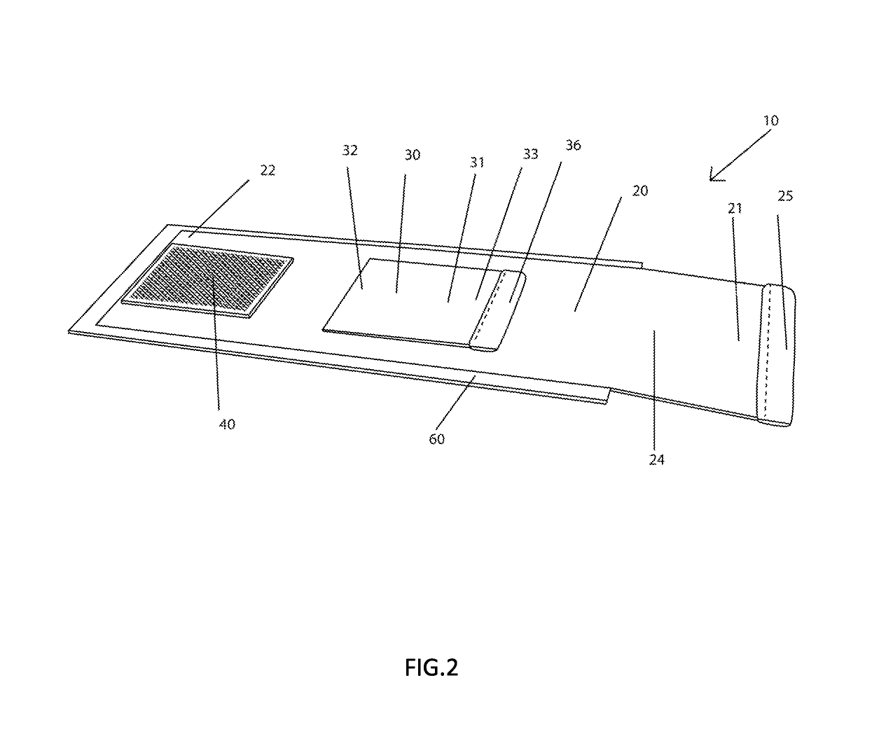

FIG. 3 is a perspective view of a cuff according to an exemplary embodiment.

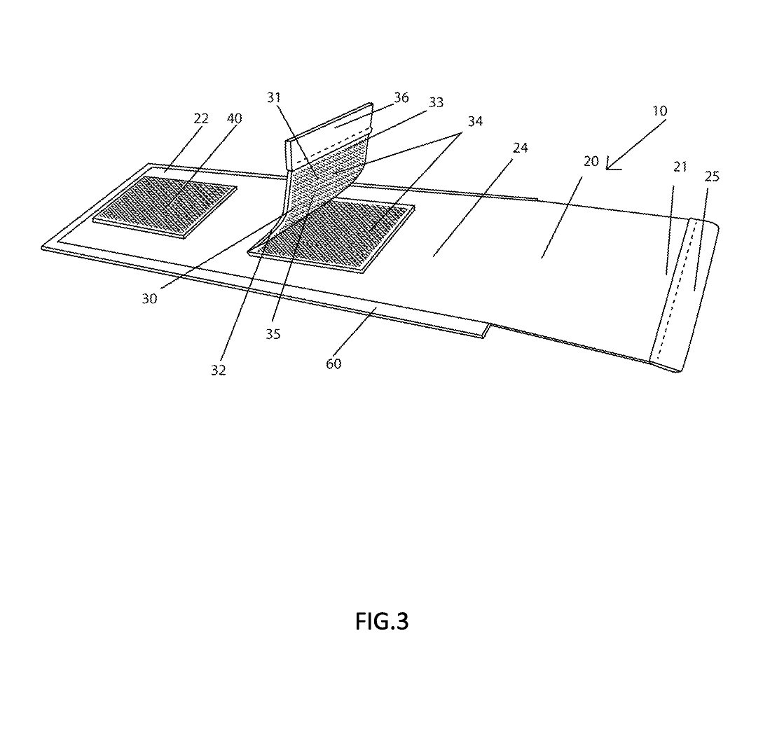

FIG. 4 is a perspective view of a cuff according to an exemplary embodiment.

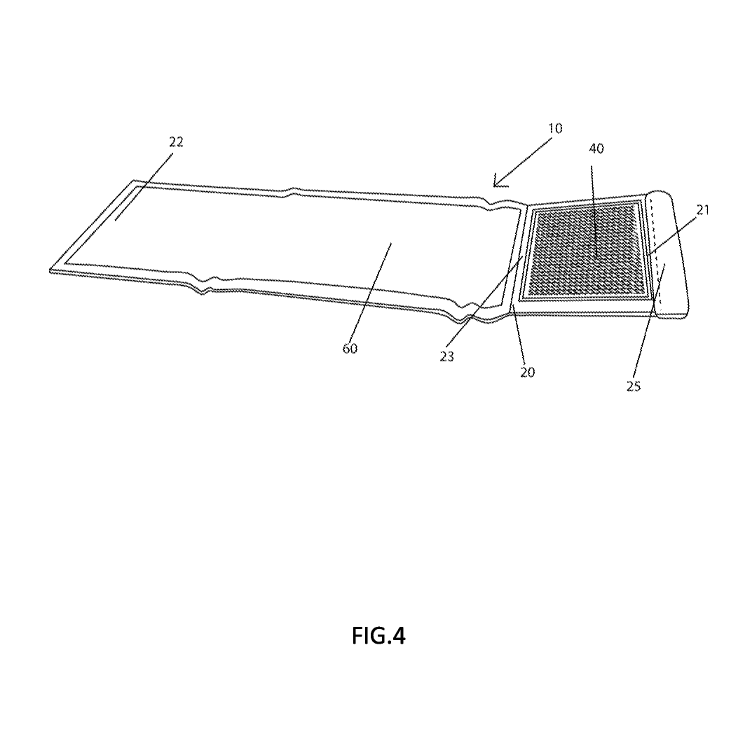

FIG. 5 is a side view of a cuff according to an exemplary embodiment.

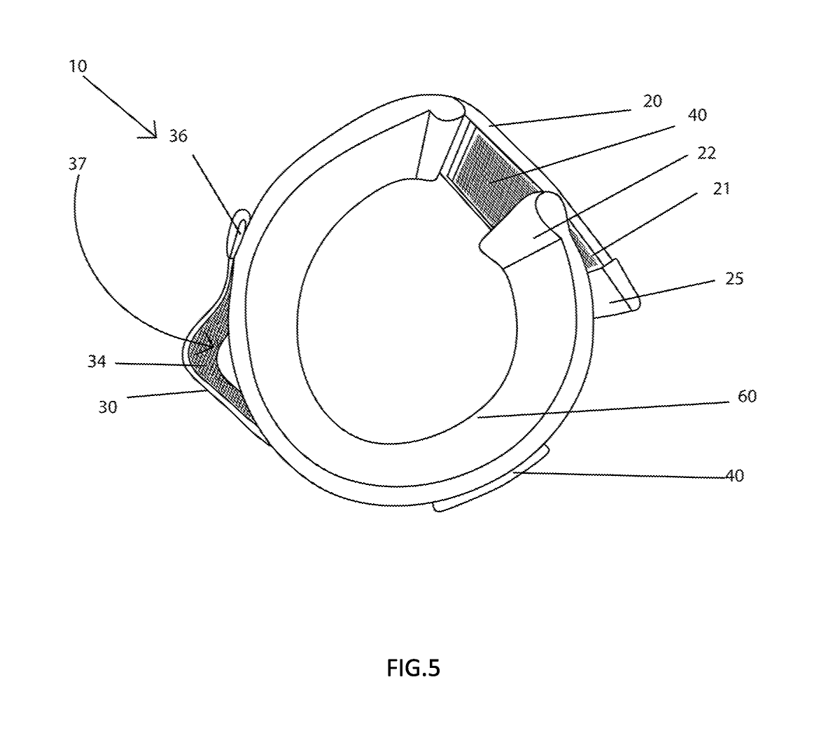

FIG. 6 is a perspective view of a cuff according to an exemplary embodiment.

### DETAILED DESCRIPTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

The present disclosure provides for a cuff 10, capable of attaching to a portion of a body of a patient, having a strap 20 with a first end 21 and a second end 22, and a cord fastener 30 for fastening a cord 15, which can also include, for example, without limitation, a cable, wire, tube, bundle or the like, of a nurse call bell or nurse call button. By securing the cord of the nurse call bell, the patient can easily access the nurse call bell when the controller of the nurse call bell becomes inaccessible by accessing the cord 15 secured to the portion of the body by the cuff 10 and pulling the cord 15, and thus the controller, towards the patient.

While the strap 20 can be any size or shaped strap 20 for fastening the cuff 10 to a patient, the strap 20 is preferably an arm strap capable of fastening the cuff 10 to the arm of a patient. In one embodiment, the strap 20 encircles a part of the body, for example, without limitation, arm, wrist, leg, torso, or the like, and is secured to the patient utilizing a compression force. The desired force to secure the strap to the patient preferably does not cause discomfort from the strap 20, but rather is a force sufficient to prevent the strap from adjusting position on the patient. The strap 20 and flap 31 can be formed of any suitable material, for example, without limitation, synthetic polymers such as elastomers or synthetic fibers, biopolymers such as cotton, wool, silk, or the like.

In one embodiment, the cuff 10 can have a cuff fastening mechanism 40 for releasably securing the cuff 10 to the body of the patient. In one embodiment, the cuff fastening mechanism 40 releasably secures the first end 21 of the strap 20 to the second end 22 of the strap 20. The cuff fastening mechanism 40 can be a hook and loop, buckle, snap, clip, zipper, or the like. By way of example, the hook can engage the interior surface 23 at the first end 21 of the strap 20 and the loop can engage an exterior surface 24 at the second end 22 of the strap 20, thereby allowing for the first end 21 to releasably engage the second end 22 by way of the hook engaging the loop when the strap 20 is positioned around a portion of the body.

The strap 20 can have a strap tab 25 positioned on the first end 21 of the strap 20 allowing for the operator to pull the first end 21 of the strap 20 away from the strap 20 and detaching the hook from the loop. The strap tab 25 can be created by engaging an additional piece of material onto the first end 21 of the strap 20 or positioning the hook component of the cuff fastening mechanism 40 engaging the interior surface 23 of the strap 20 in a manner that the hook is set back from the edge of the first end 21 of the strap 20.

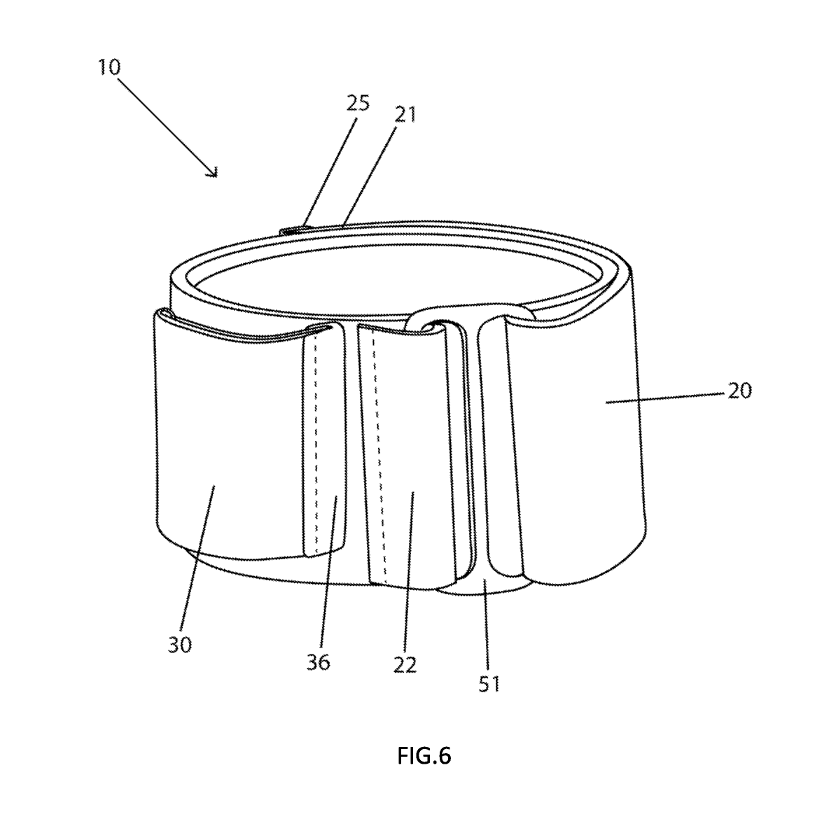

In one embodiment, as shown in FIG. 6, the cuff 10 can have an adjustable mechanism 50 for adjusting the compression force applied to the body part of the patient. In one embodiment, the adjustable mechanism 50 can have a ring 51 engaged to the first end 21 of the strap 20. The ring 51 is capable of receiving the second end 22 of the strap 20. By way of example, the hook can engage the second end 22 of the strap 20 and the loop can engage a portion of the strap 20 proximate to the second end 22 of the strap 20 between the first end 21 and second end 22. In this example, the second end 22 of the strap 20 passes through the ring 51 and the second end 22 of the strap 20 is pulled through the ring 51 until a desired compression force applied to the portion of the body is achieved. The second end 22 of the strap 20 is folded back over the middle portion of the strap 20 proximate to the second end 22 of the strap 20, thereby allowing for the first end 21 of the strap 20 to releasably engage the second end 22 of the strap 20 by way of the hook engaging the loop.

In one embodiment, the cuff 10 can have a padded portion 60 for reducing friction, irritation, pressure, or the like, onto the skin of the patient from the strap 20. The padded portion 60 can engage the interior surface 23 of the strap 20 and can extend a length comparable to the peripheral circumferential length of the portion of the body around which the strap 20 is positioned. In one embodiment, the width of the padded portion 60 is greater than the width of the strap 20 thereby allowing for the padded portion 60 to extend beyond the edge of at least one side of the strap 20. This further decreases friction, irritation, or the like onto the skin of the patient by preventing the edge of the strap 20 from contacting or touching the skin. The padded portion 60 can be made of any material suitable to reduce friction, irritation, or the like, for example without limitation, bacterial resistant fabrics, anti-microbial resistant fabrics, synthetic polymers such as elastomers, synthetic fibers, polyester, biopolymers such as cotton, wool, silk, or the like.

In one embodiment, the cuff 10 can have a cord fastener 30 for releasably securing the cord to the strap 20, thereby securing the cord to the portion of the body of the patient. The cord fastener 30 can receive the cord 15 of a nurse call bell. The cord fastener 30 can have a flap 31 with a first end 32 and a second end 33, and a cord fastening mechanism 34. The first end 32 of the flap 31 can engage the exterior surface 24 of the strap 20. The first 32 end of the flap 31 can engage the exterior surface 24 of the strap 20 by any suitable means, for example, without limitation, sewing, gluing, stapling, or the like.

In one embodiment, the cord fastening mechanism 34 releasably secures the second end 33 of the flap 31 to the exterior surface 24 of the strap 20. The cord fastening mechanism 34 can be a hook and loop, buckle, snap, clip, zipper, or the like. By way of example, the hook can engage the interior surface 35 of the flap 31 and the loop can engage the exterior surface 24 of the strap 20, thereby when hook of the interior surface 35 of the flap 31 touches the loop of the exterior surface 24 of the strap, the flap 31 is releasably engaged to the strap 20 by way of the hook engaging the loop.

The flap 31 can have a flap tab 36 positioned on the second end 33 of the flap 31 allowing for the operator to pull the flap 31 away from the strap 20 and detach the hook from the loop. The flap tab 36 can be created by engaging an additional piece of material onto the second end 33 of the flap 31 or positioning the hook engaging the interior surface 35 of the flap 31 in a manner that the hook is not positioned on the edge of the second end 33 of the flap 31.

In operation, the flap 31 is pulled away from the exterior surface 24 of the strap 20 and a portion of a cord 15 is placed within the area of the loop on the exterior surface 24 of the strap 20. The flap 31 is then placed on top of the cord 15 and the hook engaging the interior surface 35 of the flap 31 engages the loop engaging the exterior surface 24 of the strap 20 thereby forming a flap loop 37. The location of the cord 15 within the flap loop 37 secures the cord to the strap 20 and/or prevents the cord from falling away from the portion of the body. While the cord 15 can be loosely or tightly secured to the strap 20, the cord 15 is preferably loosely secured to the strap 20 thereby allowing for the cord 15 to traverse or slide within the flap loop 37.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. A cuff device for securing a cord of a nurse call button to a portion of a body, said device comprising:
a strap having an interior surface, an exterior surface, a first end, and a second end, wherein said strap is capable of encircling a portion of the body,
a padded portion engaged to the interior surface of the strap,
a cuff fastening mechanism capable of releaseably securing the cuff device to a portion of the body, and
a cord fastener capable of securing the cord to the strap.

2. The device of claim 1 wherein said padded portion is capable of reducing friction between the strap and the skin of the portion of the body.

3. The device of claim 1 wherein said padded portion is capable of reducing irritation between the strap and the skin of the portion of the body.

4. The device of claim 1 wherein the padded portion comprises a width greater than the width of the strap.

5. The device of claim 1 wherein said cord fastener comprises
a cord fastening mechanism, and
a flap having a first end and a second end,
wherein said cord fastening mechanism is capable of releaseably engaging the second end of the flap to the exterior surface of the strap.

6. The device of claim 4 wherein said first end of the flap engages the exterior surface of the strap.

7. The device of claim 4 wherein said flap comprises a flap tab engaged to the second end of the flap.

8. The device of claim 1 further comprising a strap tab engaging the first end of the strap.

9. The device of claim 1 further comprising an adjustable mechanism capable of adjusting the compression force applied to a portion of the body.
